(19) United States
(12) Patent Application Publication
(10) Pub. No.: US 2026/0229080 A1
(43) Pub. Date: Aug. 6, 2026

(54) AUTOMATED SELF SECURING ACTUATOR APPARATUS AND METHOD OF OPERATION

(71) Applicant: Crane Payment Innovations Limited, Royton, Oldham (GB)

(72) Inventors: David Taylor, Bolton (GB); Wladislaw Merems, Stade (DE); Dieter Wenskus, Beckdorf (DE)

(21) Appl. No.: 19/149,281

(22) PCT Filed: Jan. 24, 2024
(86) PCT No.: PCT/GB2024/050187

§ 371 Date: Jul. 18, 2025

(30) Foreign Application Priority Data
Jan. 27, 2023 (GB) 2301220.6
Jun. 26, 2023 (GB) 2309602.7

(51) Int. Cl. G07D 1/00; F16H 19/08; G07D 11/14

(52) U.S. Cl. CPC G07D 1/00; F16H 19/08; G07D 11/14; G07D 2201/00

(57) ABSTRACT

An apparatus comprising an actuatable portion, an actuator portion comprising at least one drive element configured to move along an arced path between first and second configurations, and at least one limit region. The at least one drive element is configured to sequentially move along a first section of the arced path to engage a receiving part of the actuatable portion at a first position of the actuatable portion, move along a second section of the arced path to actuate the actuatable portion from the first position to a second position of the actuatable portion, move along a third section of the arced path to disengage the receiving part at the second position of the actuatable portion, and move along a fourth section of the arced path to secure the actuatable portion in the second position against the at least one limit region.

### CROSS REFERENCE TO RELATED APPLICATIONS

This application is a 371 National Stage of International Application No. PCT/GB 2024/050187, filed Jan. 24, 2024, which claims priority to United Kingdom Patent Application Nos. GB 2301220.6, filed Jan. 27, 2023, and GB 2309602.7, filed Jun. 26, 2023, the disclosures of which are herein incorporated by reference.

### TECHNICAL FIELD

This specification relates to an automated self securing actuator apparatus. The actuator apparatus may be implemented in a money item gate apparatus, for example as part of a system for receiving, processing and dispensing money items.

### BACKGROUND

Money item handling systems can be configured to perform various functions, such as one or more of receiving, processing, storing and dispensing money items. For example, a money item handling system may receive money items through a money item inlet. Such money item inlets allow money items to enter the system from the exterior environment. It may be necessary to direct the money items into different routings, for example in order to return money items to a user or to process the money items at suitable equipment inside the system.

### SUMMARY

This specification presents a money item gate apparatus, comprising: an actuatable portion; an actuator portion comprising at least one drive element configured to move along an arced path between first and second configurations; and at least one limit region; wherein the at least one drive element is configured to sequentially: move along a first section of the arced path to engage a receiving part of the actuatable portion at a first position of the actuatable portion; move along a second section of the arced path to actuate the actuatable portion from the first position to a second position of the actuatable portion; move along a third section of the arced path to disengage the receiving part at the second position of the actuatable portion; and move along a fourth section of the arced path to secure the actuatable portion in the second position against the at least one limit region.

The at least one drive element may be configured to secure the actuatable portion in the second position by exerting a force on the actuatable portion against the at least one limit region.

The at least one drive element may be configured to exert the force on the actuatable portion by applying a push force on a first exterior edge of the actuatable portion against the at least one limit region.

The first exterior edge of the actuatable portion may be on a different side of the actuatable portion to the receiving part.

The first exterior edge of the actuatable portion may be on a substantially opposite side of the actuatable portion to a second exterior edge of the actuatable portion.

In the second position the second exterior edge of the actuatable portion may be in abutment with the at least one limit region.

In the second position a gate element of the actuatable portion may be in abutment with the at least one limit region.

The at least one limit region may comprise a first end stop.

The apparatus may comprise at least one further limit region.

In the first position, the actuatable portion may be in abutment with the at least one further limit region.

The at least one further limit region may comprise a second end stop.

Movement of the at least one drive element along the first section of the arced path may start at a first lock configuration of the actuator portion in which the at least one drive element secures the actuatable portion in the first position.

In the first lock configuration the actuatable portion may be secured in the first position by contact with the at least one drive element.

Movement of the at least one drive element along the fourth section of the arced path may end in a second lock configuration of the actuator portion in which the at least one drive element secures the actuatable portion in the second position.

In the second lock configuration the actuatable portion may be secured in the second position by contact with the at least one drive element.

The actuatable portion may comprise a planar engagement region including the receiving part.

The receiving part may comprise a recess in the actuatable portion into which the at least one drive element is configured to move at the end of the first section of the arced path.

The at least one drive element may be configured to move out of the recess at the end of the third section of the arced path.

The at least one drive element may comprise a pin which fits into the recess and applies rotary force to the actuatable portion as the actuatable portion moves between the first and second positions.

The actuatable portion may be mounted on a pivot to facilitate stable movement of the actuatable portion between the first and second positions.

The actuatable portion may comprise a gate element which, in the first position, facilitates a flow of money items into a first money item routing and, in the second position, facilitates a flow of money items into a second money item routing.

In the first position, the gate element may block entry of money items into the second routing.

In the second position, the gate element may block entry of money items into the first routing.

The actuator portion may further comprise a rotatable element having a curved perimeter surface for cooperating with at least one correspondingly curved surface of the actuatable portion adjacent to the receiving part.

Cooperation between the curved perimeter surface of the rotatable element and the at least one correspondingly curved surface of the actuatable portion may comprise the curved perimeter surface sliding with respect to the correspondingly curved surface of the actuatable portion as the at least one drive element moves along the arced path.

The apparatus may further comprise an electrically powered drive apparatus configured to selectively move the at least one drive element along the arced path.

The at least one drive element may be configured to continuously and uninterruptedly move along the arced path in a first direction to cause the actuatable portion to be moved from the first position to the second position.

The at least one drive element may be configured to continuously and uninterruptedly move along the arced path in a second direction opposite to the first direction to cause the actuatable portion to be moved from the second position to the first position.

This specification also presents a method of operating a money item gate apparatus, comprising: moving at least one drive element of the money item gate apparatus along a first section of an arced path to engage a receiving part of an actuatable portion at a first position of the actuatable portion, wherein the at least one drive element is configured to move along the arced path between first and second configurations;
moving the at least one drive element along a second section of the arced path to actuate the actuatable portion from the first position to a second position of the actuatable portion; moving the at least one drive element along a third section of the arced path to disengage the receiving part at the second position of the actuatable portion; and moving the at least one drive element along a fourth section of the arced path to secure the actuatable portion in the second position against at least one limit region of the money item gate apparatus.

This specification also presents computer readable instructions which, when executed by at least one computing apparatus, cause the at least one computing apparatus to perform the method.

This specification also presents a non-transitory, tangible computer readable storage medium storing computer readable instructions which, when executed by at least one computing apparatus, cause the at least one computing apparatus to perform the method.

Example implementations are described below with reference to the accompanying figures.

### BRIEF DESCRIPTION OF THE DRAWINGS

FIG. 1 is a perspective cut-away view of aspects of an automated money item handling system which includes a money item inlet.

FIG. 2 is a perspective illustration of an inlet control apparatus which includes a gate apparatus and a flow restrictor apparatus.

FIG. 3 is a perspective illustration of a gate apparatus including an actuator portion, an actuatable portion and a drive apparatus of an automated self securing actuator apparatus.

FIG. 4A is a perspective illustration of a gate apparatus including an actuator portion in a first lock configuration and an actuatable portion in a correspondingly secured first position.

FIG. 4B is a side view of an actuator portion in a first lock configuration, an actuatable portion in a correspondingly secured first position and elements of a drive apparatus including a worm gear.

FIG. 5A is a perspective illustration of a gate apparatus including an actuator portion in a first intermediate configuration and an actuatable portion in a correspondingly unlocked first position.

FIG. 5B is a side view of an actuator portion in a first intermediate configuration, an actuatable portion in a correspondingly unlocked first position and elements of a drive apparatus including a worm gear.

FIG. 5C is a perspective illustration of an actuator portion in a first intermediate configuration, an actuatable portion in a correspondingly unlocked first position and elements of a drive apparatus including a worm gear and a toothed drive gear.

FIG. 6A is a side view of an actuator portion in a second intermediate configuration, an actuatable portion in a correspondingly actuated position and elements of a drive apparatus including a worm gear.

FIG. 6B is a perspective illustration of an actuator portion in a second intermediate configuration, an actuatable portion in a correspondingly actuated position and elements of a drive apparatus including a worm gear and a toothed drive gear.

FIG. 7A is a perspective illustration of a gate apparatus including an actuator portion in a third intermediate configuration and an actuatable portion in a correspondingly unlocked second position.

FIG. 7B is a side view of an actuator portion in a third intermediate configuration, an actuatable portion in a correspondingly unlocked second position and elements of a drive apparatus including a worm gear.

FIG. 7C is a perspective illustration of an actuator portion in a third intermediate configuration, an actuatable portion in a correspondingly unlocked second position and elements of a drive apparatus including a worm gear and a toothed drive gear.

FIG. 8A is a perspective illustration of a gate apparatus including an actuator portion in a second lock configuration and an actuatable portion in a correspondingly secured second position.

FIG. 8B is a side view of an actuator portion in a second lock configuration, an actuatable portion in a correspondingly secured second position and elements of a drive apparatus including a worm gear.

FIG. 8C is a perspective illustration of an actuator portion in a second lock configuration, an actuatable portion in a correspondingly secured second position and elements of a drive apparatus including a worm gear and a toothed drive gear.

FIG. 9A is a side view of an actuator portion in a first lock configuration, an actuatable portion in a correspondingly secured first position and elements of a frame adjacent to the actuator and actuatable portions.

FIG. 9B is a side view of an actuator portion in an intermediate configuration, an actuatable portion in a correspondingly actuated position and elements of a frame adjacent to the actuator and actuatable portions.

FIG. 9C is a side view of an actuator portion in a second lock configuration, an actuatable portion in a correspondingly secured second position and elements of a frame adjacent to the actuator and actuatable portions.

FIG. 10 is a flow diagram of operational stages of an automated self securing actuator apparatus and associated gate apparatus.

FIG. 11 is a block diagram of components of a system including an automated self securing actuator apparatus, an electrically powered drive apparatus and a control apparatus in communication with the drive apparatus.

FIG. 12 is a perspective view of an exterior of an automated money item handling system including a flow restrictor apparatus, where a flow restrictor element is in a fully closed configuration.

FIG. 13 is a perspective view of an exterior of an automated money item handling system including a flow restrictor apparatus, where a flow restrictor element is in a fully open configuration.

FIG. 14 is a perspective view of an exterior of an automated money item handling system including a flow restrictor apparatus, where a flow restrictor element is in a partially open configuration.

### DETAILED DESCRIPTION

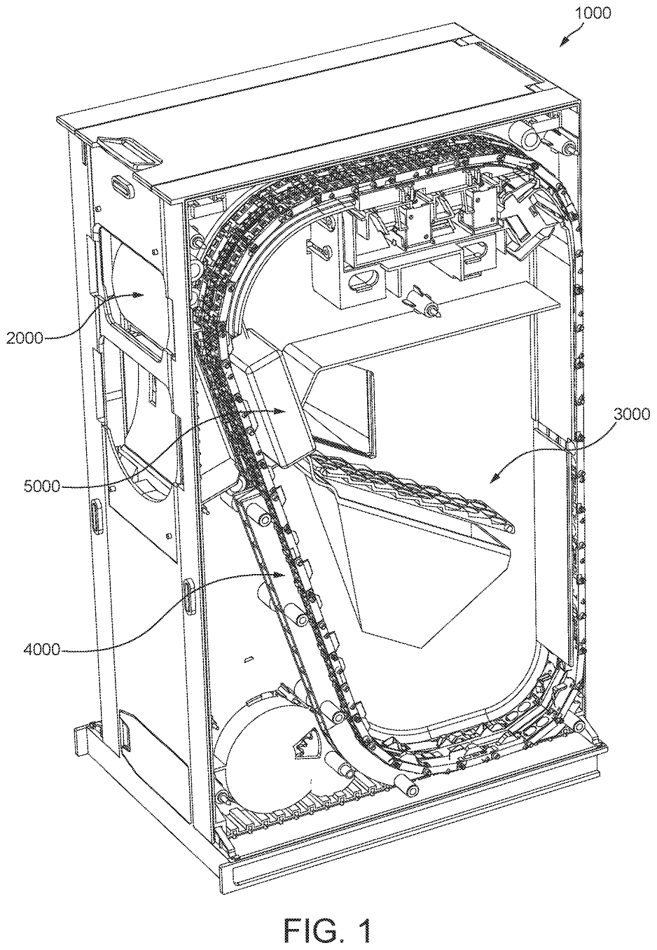

An example arrangement for a money item handling system 1000 is illustrated in FIG. 1. As can be seen from this cut-away illustration, the system 1000 comprises a money item inlet region 2000 through which money items can be fed into the system 1000 from an exterior of the system housing. Money items which are successfully fed through the inlet region 2000 may enter the system 1000 and can be directed, for example via a debris filter 3000, to a pay-in module or other money item receiving apparatus of the money item handling system 1000.

In the illustrated example, the money item receiving apparatus includes a money item conveyor 4000 which is configured to collect money items received at the conveyor 4000 from the inlet region 2000 and convey the money items through a money item validation region 5000 of the conveyor 4000. Here, one or more validators may be deployed to determine the acceptability of the money items to the system 1000. Money items which are determined to be acceptable, such as those determined to be authentic currency, may be routed to a money item storage region or another internal part of the system 1000.

The arrangement of components illustrated in FIG. 1 and explained above is intended to provide context to the apparatuses and methods which will now be described.

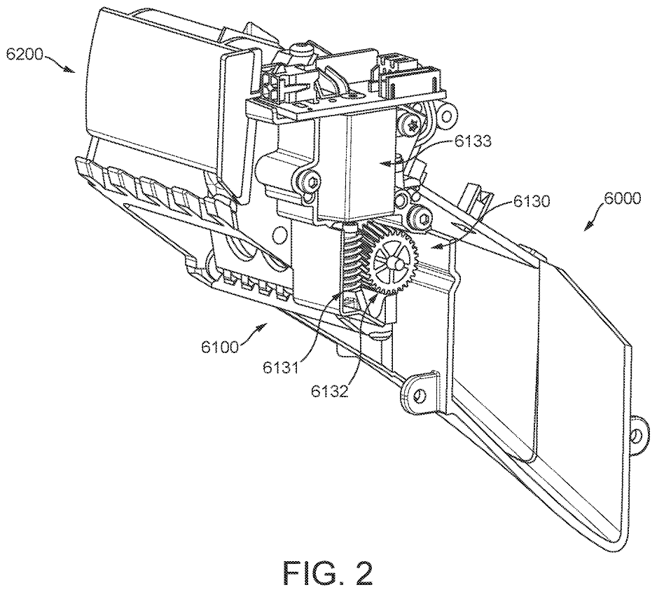

FIG. 2 shows an inlet control apparatus 6000 which is configured for use in a money item handling system such as the system 1000 shown in FIG. 1. The inlet control apparatus 6000 comprises a gate apparatus 6100 which is operable to selectively control movement of money items into one or more paths of the system 1000. As will be described further below, the inlet control apparatus 6000 may also comprise a flow restriction apparatus 6200 which is operable to selectively block or unblock the money item inlet 2000 of the system 1000. Both the gate apparatus 6100 and the flow restriction apparatus 6200 are included in FIG. 2.

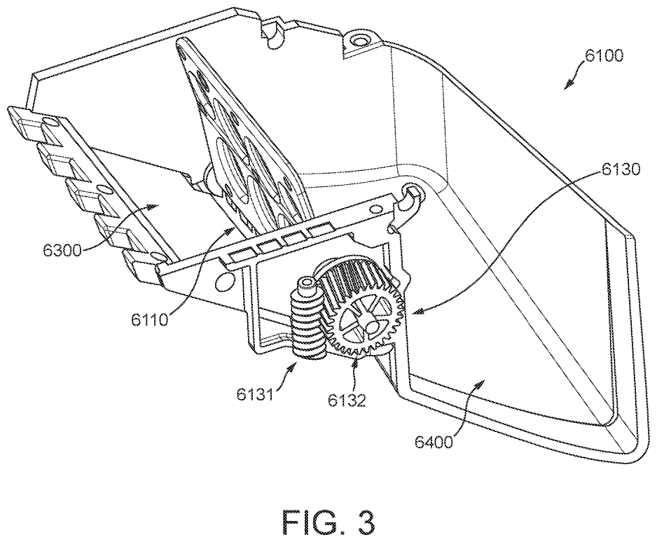

A perspective view of the gate apparatus 6100 is shown in FIG. 3. Here, the gate apparatus 6100 is illustrated without the flow restriction apparatus 6200. The gate apparatus 6100 comprises an actuatable portion and an actuator portion. The actuatable portion is moveable between first and second positions to control a flow of money items within the inlet control apparatus 2000. For example, in a first position, the actuatable portion may be configured to open a first money item routing 6300 so that money items moving into the gate apparatus 6100 from the system inlet 2000 naturally flow into the first routing 6300 under gravity. The first routing 6300 may in some implementations route money items directly back to a collection region at the exterior of the system 1000.

In the first position, in addition to opening an entrance to the first routing 6300, the actuatable portion may also close an entrance to a second money item routing 6400. While in the illustrated examples money items will preferentially enter the first routing 6300 under gravity whenever the entrance to the first routing 6300 is open, closure of the entrance to the second routing 6400 by the actuatable portion provides an extra means of ensuring that all money items moving through the gate apparatus 6100 enter the first routing 6300 when the actuatable portion is in the first position.

In a second position, the actuatable portion may be configured to open the entrance to the second routing 6400 while closing the entrance to the first routing 6300. For example, as will be described in more detail further below, the actuatable portion may when in the second position form a bridge across the entrance to the first routing 6300 so as to divert money items to the second routing 6400. In this type of implementation, money items moving through the gate apparatus 6100 from the system inlet 2000 slide over the bridge provided by the actuatable portion and into the second routing 6400. The second routing 6400 may direct money items towards internal regions of the money item handing system 1000 for processing and/or storage, for example as briefly outlined above with respect to FIG. 1.

As shown in FIGS. 2 and 3, the gate apparatus 6100 also comprises a drive apparatus 6130 which is coupled to the actuator portion. The drive apparatus 6130 comprises a powered drive mechanism which may, for example, include a worm gear 6131 engaged with a toothed drive wheel 6132 as shown in FIGS. 2 and 3. In such an implementation, the worm gear 6131 is selectively rotated by an electric motor 6133 of the drive apparatus 6130 to produce a corresponding rotation in the toothed drive wheel 6132. A direct coupling between the toothed drive wheel 6132 and the actuator portion causes the actuator portion to move with the rotation of the drive wheel 6132.

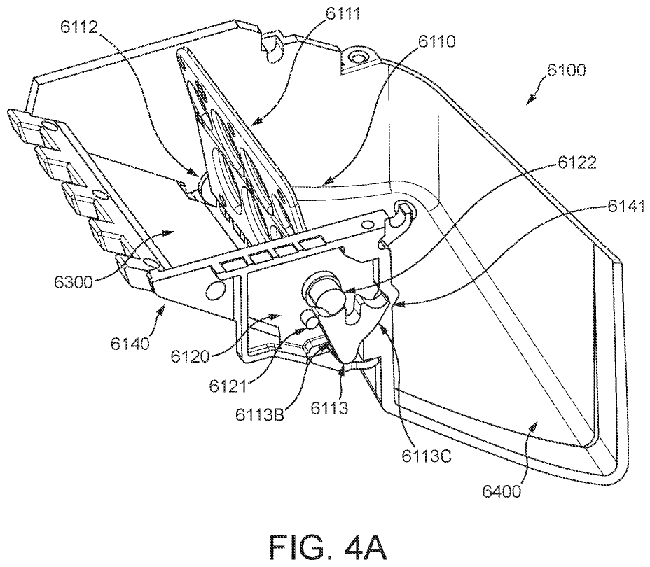

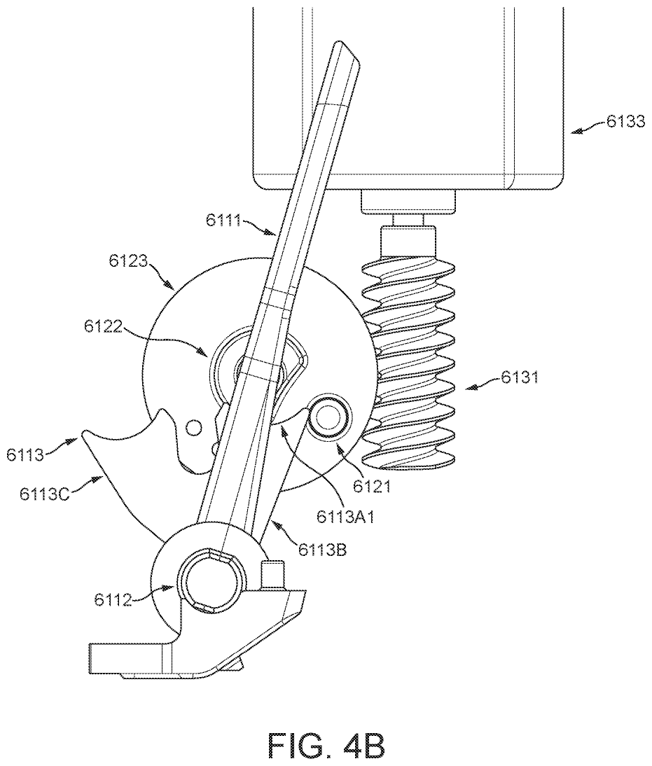

Examples of the actuatable portion 6110 and actuator portion 6120 are illustrated in FIG. 4A. FIG. 4A shows the actuator portion 6120 without the components of the drive apparatus 6130 illustrated in FIGS. 2 and 3. An entrance to the first routing 6300 is shown as open, while an entrance to the second routing 6400 is shown as closed off by the position of a gate element 6111 and therefore inaccessible to money items entering the inlet control apparatus 6000 via the system inlet 2000.

The gate element 6111 may be part of the actuatable portion 6110 and may be coupled to a hinge 6112 or other suitable pivot region of the money item gate apparatus 6100. The gate element 6111 may be actuated around the hinge 6112 between the first and second positions referred to above. To facilitate this, the actuatable portion 6110 may comprise an engagement region 6113 which is engageable by the actuator portion 6120 to drive movement of the gate element 6111 between the first and second positions. For example, the engagement region 6113 may be directly connected, for instance as part of a single piece plastics moulding or by means of another fixed connection, to the gate element 6111 so that movement of the engagement region 6113 produces a corresponding movement of the gate element 6111. Cooperation between the actuator portion 6120 and the engagement region 6113 of the actuatable portion 6110 is described in more detail below with respect to the sequence of views shown in FIGS. 4A-8C and 9A-9C.

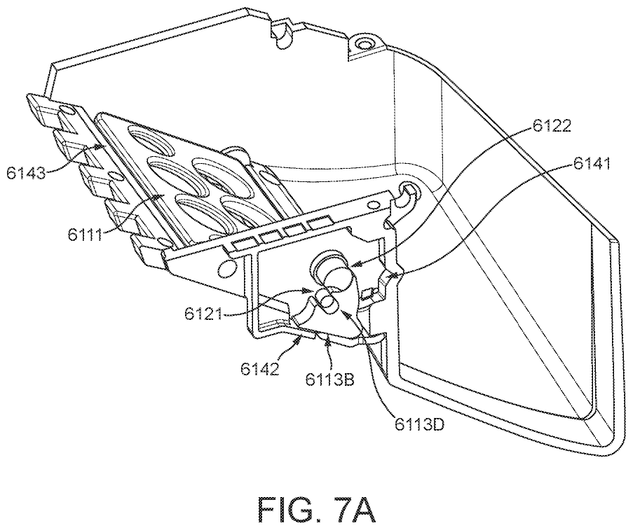

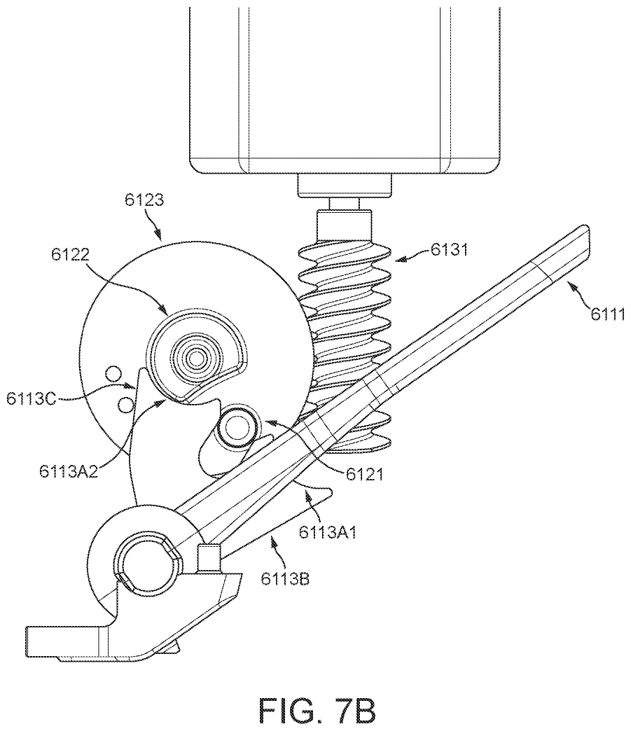

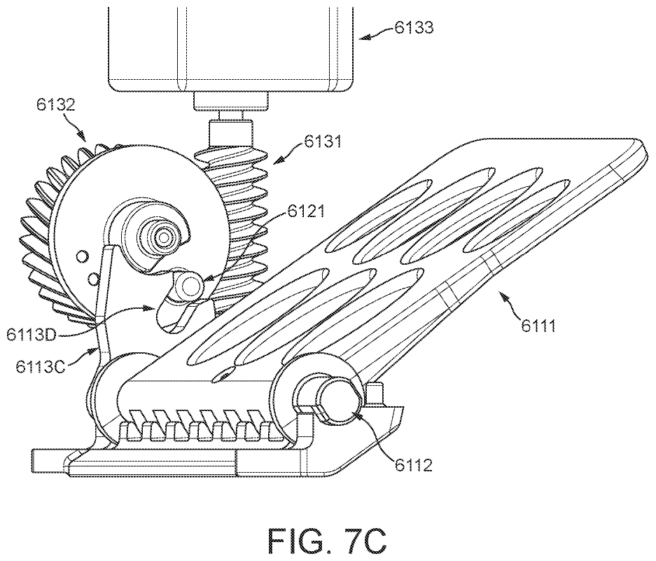

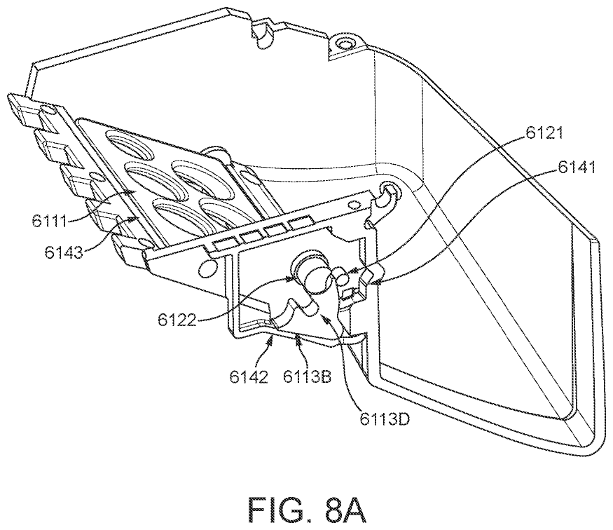

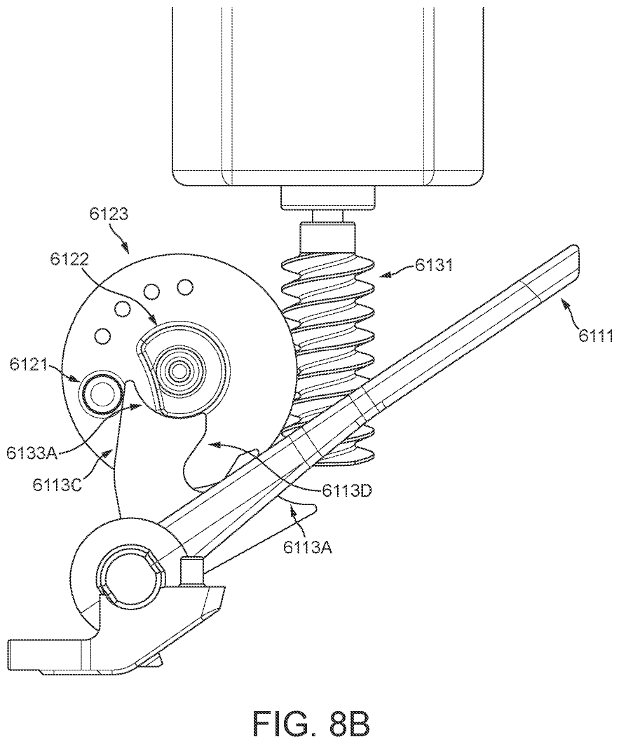

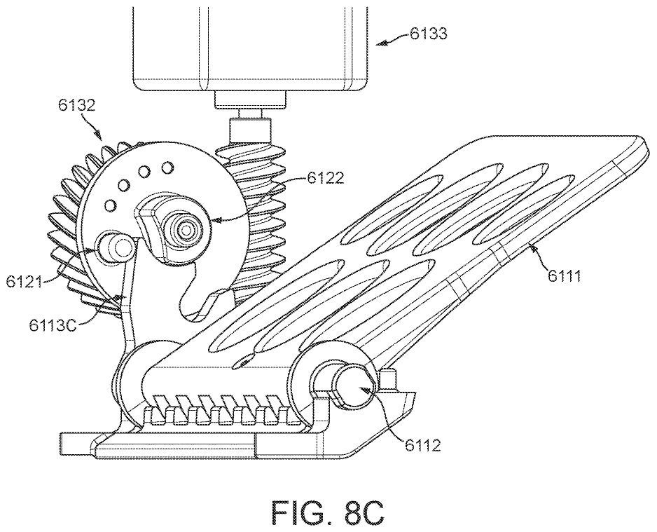

In FIG. 4A, the actuator portion 6120 is illustrated in a first lock configuration and the actuatable portion 6110 is illustrated locked in its first position. In this arrangement, a drive element 6121 of the actuator portion 6120, such as a drive pin or other protrusion, secures the actuatable portion 6110 in the first position. The configuration of the actuator portion 6120 is such that the actuatable portion 6110 is held by the drive element 6121 against its limit of motion. In this way, the configuration of the actuator portion 6120 ensures that the first position of the actuatable portion 6110 remains consistent and functionally accurate each time the actuatable portion 6110 is actuated into the first position. Any potential variability which may otherwise by associated with the first position, for example due to inherent tolerances in the materials involved or some requirement for very precise motor operation in the drive apparatus 6130, is avoided. The absorption of tolerance related uncertainties in the first and second positions of the actuatable portion 6110 is described in more detail below with respect to FIGS. 7A and 8A.

In the illustrated examples, the drive element 6121 of the actuator portion 6120 secures the actuatable portion 6110 in the first position by pushing the actuatable portion 6110 against a first limit region and locking the actuatable portion 6110 in place. In the illustrated examples, the first limit region is implemented in the form of a first end stop 6141 provided by a portion of the frame 6140 of the gate apparatus 6100.

For example, the first end stop may be provided by a portion 6141 of the frame 6140 which is directly adjacent to the engagement region 6113. In this type of implementation, upon being actuated to the first position by the actuator portion 6120, a side edge 6113C of the engagement region 6113 comes into contact with the adjacent portion 6141 of the frame 6140. The drive element 6121 acts on the engagement region 6113 to push the engagement region 6113 against the end stop provided by the adjacent portion 6141 of the frame 6140 and lock the actuatable portion 6110 in the first position. In the example of FIG. 4A, this would involve the drive element 6121 moving in an anticlockwise direction around an arced travel path. Further explanation and context to this is provided further below. The act of pushing the engagement region 6113 against the adjacent portion 6141 of the frame 6140 and locking it in place in the manner outlined above can prevent further movement of the actuatable portion 6110 as a whole and ensure accurate and consistent positioning of the gate element 6111.

Additionally or alternatively, in the implementation shown in FIG. 4A, the first end stop may be provided by a portion of the frame 6140 which acts on the gate element 6111. For example, the first end stop may be provided by a roof [not shown] or other suitably positioned element of the frame 6140 against which the gate element 6111 is pushed by the actuator portion 6120. In this type of implementation, upon being actuated to the first position by the actuator portion 6120, the distal end of the gate element 6111, furthest from the hinge 6112, comes into contact with the first end stop and is prevented from moving further in that same direction. The drive element 6121 acts on the engagement region 6113 to push the gate element 6111 against the end stop and lock the actuatable portion 6110 in the first position. In the example of FIG. 4A, this involves the drive element 6121 moving in an anticlockwise direction around an arced travel path.

In implementations in which the end stops are provided by contact between the gate element 6111 and the frame 6140 of the gate apparatus 6100, as outlined directly above, flexibility in the gate element 6111 may allow the gate element 6111 to flex as its distal end is pushed against the end stop by the actuator portion 6120. For example, the planar gate element 6111 shown in the figures may bend by a small amount along its length as its distal end, furthest from the hinge 6112, is pushed against a roof of the gate apparatus 6100 by the actuator portion 6120. This flexing of the gate element 6111 may have the effect of reducing the ‘hard stop’ effect experienced by the drive element 6121 as it acts on the engagement region 6113 to push the gate element 6111 against the end stop and lock the actuatable portion 6110 in position.

In this way, a degree of flexibility in the gate element 6111 may contribute to a further improvement in the robustness and durability of the system as a whole by reducing the instantaneous force experienced by the drive element 6121 as the gate element 6111 is pushed against the end stop. The likelihood of damage to the drive element 6121 through repeated movements of the gate element 6111 into the first position (or second position) over a lifetime operation of the system is reduced. For example, in implementations of the kind shown in the figures, the likelihood of the protruding drive element 6121 being broken off the remainder of the actuator portion 6120 by repeated abutments with the side edges of the engagement region 6113 is reduced by the gate element 6111 flexing as it is pushed against the first (or second) end stop.

Another illustration of the first position of the actuatable portion 6110 and first lock configuration of the actuator portion 6120 is shown in FIG. 4B. Here, the gate apparatus 6100 is viewed from the opposite side to that shown in FIG. 4A. The majority of the frame 6140 of the gate apparatus 6000, including the end stops discussed above, is not illustrated in FIG. 4B for reasons of clarity. It can be seen from FIG. 4B that, while in the first lock configuration, a curved exterior surface of a rotatable element 6122 of the actuator portion 6120 fits against a corresponding curved surface 6113A1 of the engagement region 6113 to provide support to the engagement region 6113. This rotatable element 6122 of the actuator portion 6122 may be referred to as a blocking disc.

As shown in FIGS. 4A-B, when the actuator portion 6120 is in the first lock configuration the actuatable portion 6110 may be held in the first position by a plurality of contact points with other elements of the gate apparatus 6100. A first of these contact points is provided by abutment between the drive element 6121 and a first side surface 6113B of the engagement region 6113. A second of the contact points is provided by contact between the actuatable portion 6110 and the first limit region discussed above. For example, the roof or another part of the frame 6140 of the gate apparatus 6100 may provide a first end stop against which the distal end of the gate element 6111 is secured by the actuator portion 6120. Alternatively, the first end stop may be provided by abutment between a second side surface 6113C of the engagement region 6113, opposite the first side surface 6113B, and an adjacent portion 6141 of the frame 6140. A third of the contact points may be provided by slideable contact between the curved surface of the rotatable element 6122 and the correspondingly curved surface 6113A1 on a third side of the engagement region 6113. In the configuration shown in FIGS. 4A-B, the actuatable portion 6110, including the gate element 6111 and the engagement region 6113, is unable to freely move out of the first position.

In a type of implementation which has not so far been described and is not specifically shown in the figures, the first limit region against which the actuatable portion 6110 is secured by the actuator portion 6120 in the first lock configuration may comprise a region of the actuator portion 6120. For example, the curved surface of the rotatable element 6122 mentioned above may be shaped so as to engage the curved surface 6133A1 of the engagement region 6113 as the actuatable portion 6110 reaches the first position shown in FIGS. 4A-B. This engagement may take the form of increased frictional engagement between the two curved surfaces when the actuatable portion 6110 reaches the first position, or direct abutment (e.g. between the curved surfaces) caused by one or more surface discontinuities. In either case, the level of engagement between the actuatable portion 6110 and the limit region on the actuator portion 6120 is sufficient to prevent further movement of the actuatable portion 6110 and thereby provide a consistently repeatable first position for the actuatable portion 6110. In this kind of implementation, abutment between the actuatable portion 6110 and the frame 6140 of the gate apparatus 6100, as described above with respect to the example end stops, is not required.

Also illustrated in FIG. 4B is an implementation of a fixed coupling between the actuator portion 6120 and the drive apparatus 6130. In particular, the drive element 6121 and rotatable element 6122 of the actuator portion 6120 are fixed, for example as part of a single piece plastics moulding, to the toothed drive wheel 6132 by an intermediate plate section 6123. Via this intermediate section 6123, rotation of the drive wheel 6132 produces corresponding movement of the drive element 6121 and rotatable element 6122 of the actuator portion 6120. Due to an axial alignment between the drive wheel 6132 and the rotatable element 6122, rotation of the drive wheel 6132 about its axis of rotation results in a corresponding rotation of the rotatable element 6122 about the same axis. This causes the curved surface of the rotatable element 6122 to slide with respect to the correspondingly curved surface 6113A1 of the engagement region 6113, as will be described in more detail further below. Meanwhile, the drive element 6121 follows an arced path around the axis of the rotating element 6122 and drive wheel 6132 due to non-alignment between their shared rotation axis and a separate principal axis of the drive element 6121.

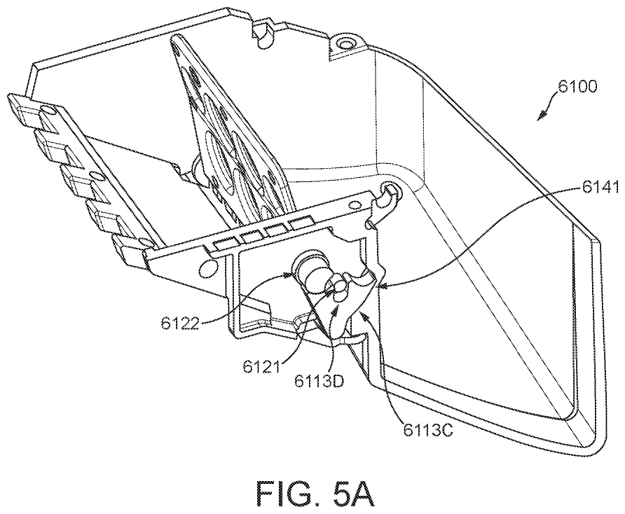

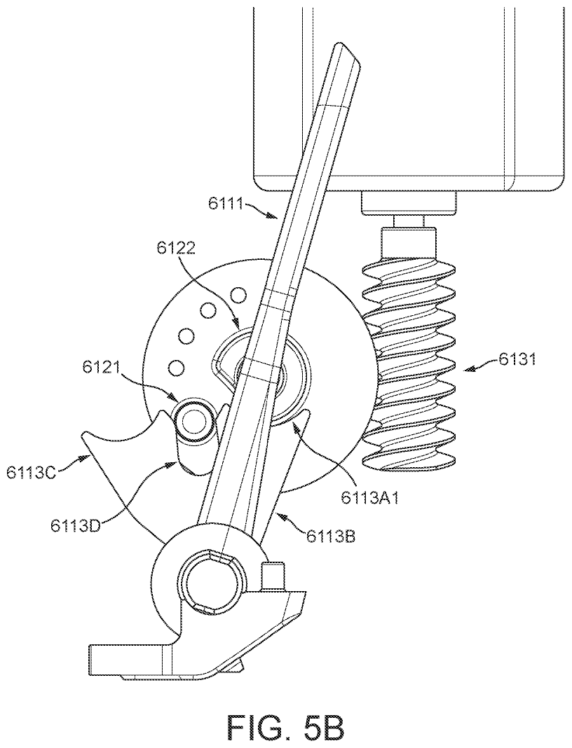

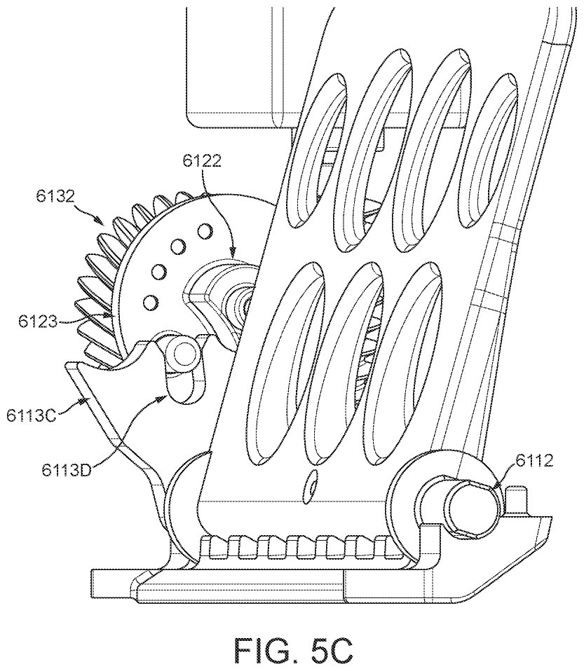

FIG. 5A is another illustration of the actuator and actuatable portions 6120, 6110 when implemented as part of the gate apparatus 6100. As with FIG. 4A, these portions 6110, 6120 are shown in absence of the components of the drive apparatus 6130 for reasons of clarity. In FIG. 5A, while the gate element 6111 and engagement region 6113 of the actuatable portion 6110 remain in the first position shown in FIGS. 4A and 4B, it can be seen that the drive element 6121 and the rotatable element 6122 of the actuator portion 6120 have been moved in a first direction, by the drive apparatus 6130, into a first intermediate configuration. In particular, the rotatable element 6122 has rotated with respect to the curved surface 6133A1 of the engagement region 6133. Additionally, the drive element 6121 has travelled in an arced path out of abutment with the first side surface 6113B of the engagement region 6113 and into partial engagement with a receiving part 6113D of the engagement region 6113. The engagement region 6113 and other elements of the actuatable portion 6110 are no longer secured in the first position by contact between the drive element 6121 and the first side surface 6113B of the engagement region 6113. Instead, the engagement between the drive element 6121 and the receiving part 6113D of the engagement region 6113 places the gate apparatus 6100 into a state from which the actuator portion 6120 is ready to move the actuatable portion 6110 out of the first position.

FIGS. 5B and 5C are further illustrations of the arrangement of the gate apparatus 6100 as shown in FIG. 5A. In both of FIGS. 5B and 5C, the drive element 6121 has moved into partial engagement with the receiving part 6113D of the engagement region 6113 of the actuatable portion 6110. Meanwhile, as also shown in FIG. 5A, contact between the curved exterior surface of the rotatable element 6122 and the correspondingly curved surface 6113A1 of the engagement region 6113 remains. While rotation of the rotatable element 6122 has caused its curved surface to slide with respect to the curved surface 6113A1 of the engagement region 6113, close alignment between these two surfaces as the drive element 6121 has moved around its arced path has continued to support the actuatable portion 6110 in the first position.

As illustrated in each of FIGS. 5A-C, the receiving part 6113D of the engagement region 6113 may be implemented as a single recess, such as a single slot, formed in the engagement region 6113. The recess may, for example, be sized to accommodate the pin or other protrusion of the drive element 6121 so that the pin or other protrusion enters the recess when moved by the drive apparatus 6300 around its arced path into alignment with the recess.

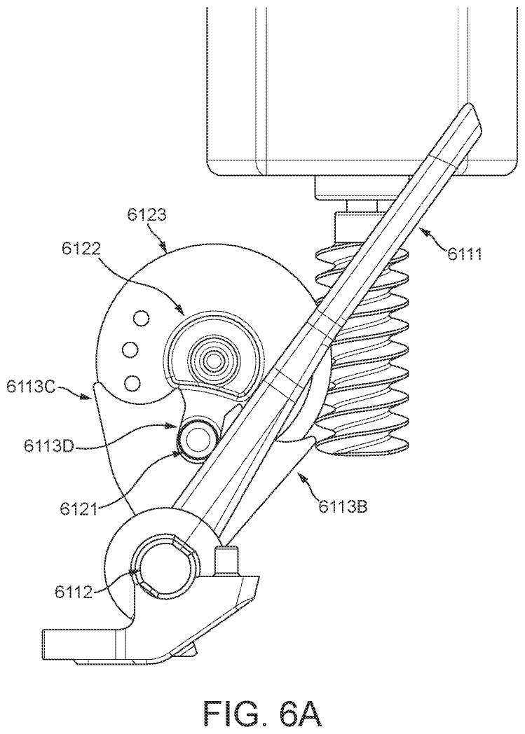

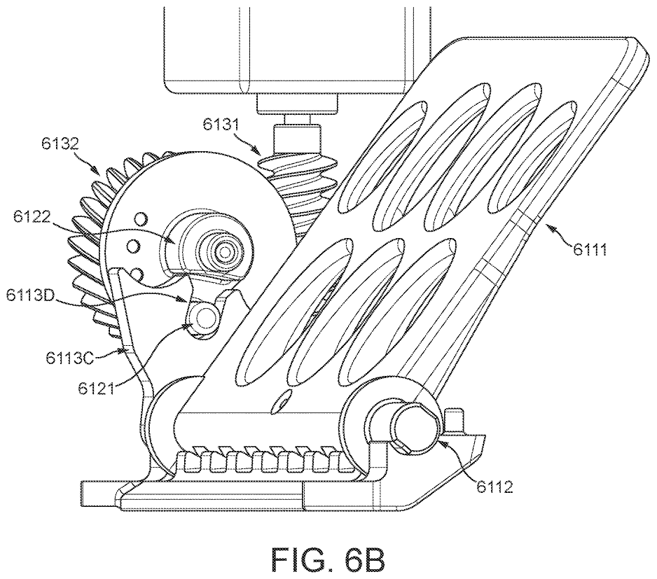

FIGS. 6A and 6B show the gate apparatus 6100 after further continued movement of the rotatable element 6122 and the drive element 6121 in the first direction. In this second intermediate configuration, the drive element 6121 is fully engaged with the receiving part 6113D of the engagement region 6113 and has actuated the actuatable portion 6110 out of the first position shown in FIGS. 4A-B and 5A-C. For example, as can be seen by a comparison of the configuration shown in FIG. 6A and the earlier configuration shown in FIG. 5B, the second side surface 6113C of the engagement region 6113 has been moved away from the previously adjacent portion 6141 of the gate apparatus frame 6140. Additionally, the curved surface of the rotatable element 6122 has moved out of contact with the correspondingly curved surface 6113A1 of the engagement region 6113. As such, in the configuration shown in FIGS. 6A and 6B, the single contact point between the actuator portion 6120 and the actuatable portion 6110 is provided by the physical engagement between the drive element 6121 and the receiving part 6113D of the engagement portion 6113.

To provide a degree of separation between the rotatable element 6122 and the engagement region 6113 in this configuration of the actuator portion 6120, the perimeter surface of the rotatable element may comprise a substantially straight section between first and second ends of the curved surface discussed above. For example, as illustrated in FIGS. 6A and 6B, the perimeter surface of the rotatable element 6122 may comprise a first section curved in a manner which is concentric with the axis of rotation of the rotatable element 6122, thereby matching the correspondingly curved surface 6113A1 of the engagement region 6113, and a second section which follows a substantially straight path between two points at either end of the curved section. The substantially straight section of the perimeter surface is located directly between the rotation axis of the rotatable element 6122 and the drive element 6121 so that, as the drive element 6121 comes into full engagement with the receiving part 6113D of the engagement region 6113, the substantially straight section of the perimeter surface of the rotatable element 6122 faces the receiving part 6113D. In this configuration, as illustrated in FIGS. 6A-B, the curved section of the perimeter surface of the rotatable part 6122 faces away from the receiving part 6113D. Unlike in the first locked configuration and the first intermediate configuration discussed above with respect to FIGS. 4A-B and 5A-C, the rotatable element 6122 is separated from the engagement region 6113.

Stable movement of the engagement region 6113 away from the first limit region discussed above may be facilitated by the hinge 6112 or alternative pivot mentioned previously with respect to the gate element 6111. In particular, both the engagement region 6113 and the gate element 6111 may be fixedly coupled to the same hinge 6112 (or alternative pivot) so that they move in unison on the same axis. As the actuatable portion 6110 transitions over its range of travel between the first limit region and a second limit region discussed further below, the gate element 6111 moves in a synchronous and corresponding manner.

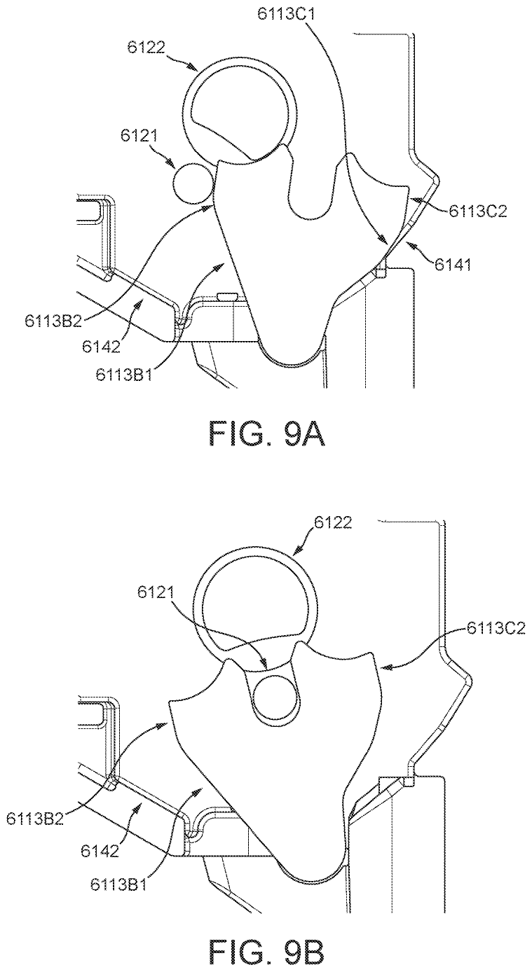

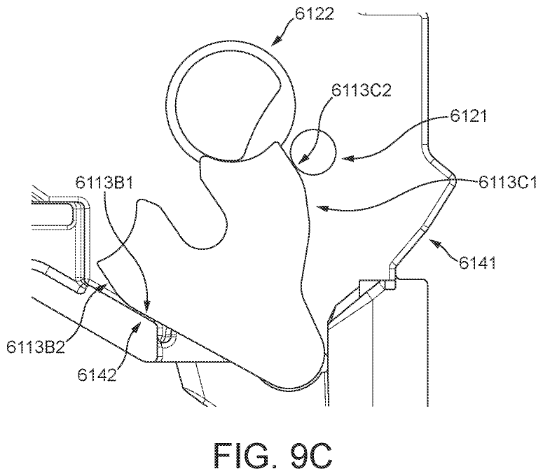

It can be seen from the illustrated examples that the engagement region 6113 may be formed from a substantially planar element with an approximately triangular shape. For example, the first and second side surfaces 6113B, 6113C mentioned above may be angled towards one another so as to meet close to the axis of the hinge 6112 or other pivot to which the planar element of the engagement region 6113 is fixedly coupled. Broadly opposite this intersection between the first and second side surfaces 6113B, 6113C is the curved surface 6113A1 and receiving part 6113D which cooperate with the actuator portion 6120. In this type of implementation, as the actuatable portion 6110 moves between the first and second limit regions at either end of its range of travel, the intersection of the first and second exterior side surfaces 6113B, 6113C remains in a similar position relative to the hinge 6112 or alternative pivot. However, the curved surface 6113A1 and receiving part 6113D at the other end of the engagement region 6113 travel over a longer path due to their relatively larger distance from the hinge 6112 or other pivot. As discussed below with respect to FIGS. 9A-9C, the specific geometries and associated design characteristics of the engagement region 6113, while being consistent with the explanation above, may vary between different implementations of the engagement region 6113.

FIGS. 7A-C show the gate apparatus 6100 after still further continued movement of the rotatable element 6122 and the drive element 6121 in the first direction. As with FIGS. 4A and 5A, in FIG. 7A the actuator and actuatable portions 6120, 6110 are shown in absence of the components of the drive apparatus 6130 for reasons of clarity. In this third intermediate configuration, as can be seen for example by a comparison of FIGS. 6B and 7C, the engagement region 6113 and associated gate element 6111 have been actuated further around the hinge 6112 or alternative pivot into a further new orientation with respect to the frame 6140 of the gate apparatus 6100. More specifically, as shown in FIG. 7A, the actuatable portion 6110, including the gate element 6111 and the engagement region 6113, has been moved close to the limit of its range of travel in proximity to the second limit region mentioned above.

As with the first limit region discussed above, the second limit region may be formed by the frame 6140 of the gate apparatus 6100. For example, as illustrated in FIG. 7A, the second limit region may comprise a portion 6143 of the frame 6140 against which the distal end of the gate element 6111 abuts when the actuatable portion 6110 is in the second position. In the illustrated example, this portion 6143 of the frame 6140 takes the form of a lip which acts as a second end stop for the actuatable portion 6120. The lip, or alternative second end stop, is arranged to prevent the gate element 6111 from being actuated beyond the second position. In this type of implementation, the gate element 6111 may flex, as described above, when pushed against the second end stop.

Additionally or alternatively, the second end stop may comprise a region 6142 of the frame 6140 which abuts the first side surface 6113B of the engagement region 6113 when the actuatable portion 6110 is moved fully into the second position. In particular, upon being actuated into the second position by the actuator portion 6120, the side edge 6113B of the engagement region 6113 may come into contact with the adjacent region 6142 of the frame 6140 and, as such, be prevented from moving further in that direction.

As best shown in FIGS. 7B and 7C, in the configuration shown in FIGS. 7A-C, rotation of the toothed drive wheel 6132 has caused the drive element 6121 of the actuator portion 6120 to begin to disengage from the receiving part 6113D of the engagement region 6113. Each view shown in FIGS. 7A-C shows the drive element 6121 now only partially engaged with the recess of the receiving part 6113D as the drive element 6121 continues to follow its arced path around the rotation axis of the toothed drive wheel 6132 and rotatable element 6122. In the illustrated examples, disengagement of the drive element 6121 from the receiving part 6113D of the engagement region 6113 occurs when the angle of the recess mentioned above aligns with the arced path of the drive element 6121. As will be described below, further continued movement of the drive element 6121 around its arced path causes the drive element 6121 to fully disengage from the engagement region 6113.

In the third intermediate configuration illustrated in FIGS. 7A-C, at which the actuatable portion 6110 of the apparatus 6100 has completed its travel, or at least substantially completed its travel, between the first and second limit regions, continued rotation of the rotatable element 6122 from the earlier intermediate configuration shown in FIGS. 6A-B has caused the curved surface of the rotatable element 6122 to partially align with a second correspondingly curved surface 6133A2 of the engagement region 6133.

As can be seen from each of FIGS. 7A-C, these first and second curved surfaces 6113A1, 6113A2 of the engagement region 6133 are located either side of the receiving part 6133D along an edge of the engagement region 6113 which is opposite the hinge 6112 or alternative pivot discussed above. For example, as shown in the figures, the recess of the receiving part 6113D may be located approximately centrally between the two curved surfaces 6113A1, 6113A2. The two curved surfaces 6113A1, 6113A2 themselves may have the same radius (but with different centres). For example, the two curved surfaces 6113A1, 6113A2 may be a mirror image of one another. In this way, each curved surface 6113A1, 6113A2 of the engagement region 6113 matches the curvature of the perimeter of the rotatable element 6122 of the actuator portion 6120 and receives a similar amount of support from the rotatable element 6112.

FIGS. 8A-C show the gate apparatus 6100 after still further continued movement of the rotatable element 6122 and the drive element 6121 of the actuator portion 6120 in the first direction. As with FIGS. 4A, 5A and 7A, in FIG. 8A the actuator and actuatable portions 6120, 6110 are shown in absence of the components of the drive apparatus 6130 for reasons of clarity. It can be seen from FIGS. 8A-C that the actuatable portion 6110, including the gate element 6111 and the engagement region 6133, is in a similar position to that described with respect to FIGS. 7A-7C.

However, the actuator portion 6120 has progressed from the third intermediate configuration shown in FIGS. 7A-C, in which the drive element 6121 was partially engaged with the receiving part 6113D of the engagement region 6113, to a second lock configuration in which the drive element 6121 secures the actuatable portion 6110 in the second position by locking the actuatable portion 6110 against the second limit region. In the illustrated examples, this may involve the gate element 6111 being secured against the lip portion 6143 of the frame 6140. Additionally or alternatively, locking the actuatable portion 6110 in the second position may involve securing the first side surface 6133B of the engagement region 6133 against the adjacent region 6142 of the frame 6140.

In this second lock configuration, the curved exterior surface of the rotatable element 6122 of the actuator portion 6120 fits against the second correspondingly curved surface 6113A2 of the engagement region 6113 to further support the engagement region 6113. To reach the second lock configuration, the drive element 6121 continues to travel in the first direction around its arced path from the third intermediate configuration shown in FIGS. 7A-C until it contacts the second side surface 6113C of the engagement region 6113 of the actuatable portion 6110. Here, possibly following a further small movement around its arced path in the same direction, the drive element 6121 stops together with the associated rotation of the rotatable element 6122. The process of stopping movement of the drive element 6121 in the second lock configuration is described further below with respect to operation of the electric motor 6133 by a control apparatus.

In a corresponding manner to the first lock configuration shown in FIGS. 4A-B, in the second lock configuration of the actuator portion 6120 the actuatable portion 6110 may be held locked in its second position by a plurality of contact points with the other elements of the apparatus 6100. A first of these contact points may be provided by abutment between the drive element 6121 and the second side surface 6113C of the engagement region 6113. A second of the contact points is provided by contact between the actuatable portion 6110 and the second limit region. For example, as outlined above and shown in FIG. 8A, the lip portion 6143 of the gate apparatus frame 6140 may provide a second end stop against which the distal end of the gate element 6111 is secured by the actuator portion 6120. Alternatively, the second end stop may be provided by abutment between the first side surface 6113B of the engagement region 6113 and the adjacent region 6142 of the frame 6140. A third of the contact points may be provided by slideable contact between the curved surface of the rotatable element 6122 and the correspondingly curved surface 6113A2 on the third side of the engagement region 6113. In the second lock configuration shown in FIGS. 8A-C, the actuatable portion 6110, including the engagement region 6113 and the gate element 6111, is unable to freely move out of the second position.

In a similar manner to that outlined above with respect to the first limit region, the second limit region may additionally or alternatively comprise a region of the actuator portion 6120. For example, the curved surface of the rotatable element 6122 mentioned above may be shaped so as to engage the second curved surface 6113A2 of the engagement region 6113 as the actuatable portion 6110 reaches the second position shown in FIGS. 8A-C. As mentioned previously, this engagement may take the form of increased frictional engagement between the curved surface of the rotatable element 6122 and the second curved surface 6113A2 of the engagement region 6113 as the actuatable portion 6110 reaches the first position, or direct abutment (e.g. between these two curved surfaces) caused by one or more surface discontinuities. In either case, the degree of engagement between the actuatable portion 6110 and the limit region on the actuator portion 6120 is sufficient to prevent further movement of the actuatable portion 6110 and thereby provide a consistently repeatable second position for the actuatable portion 6110. In this kind of implementation, abutment between the actuatable portion 6110 and the frame 6140 of the gate apparatus 6100, as described above with respect to the example end stops, is not required.

Consistent with the implementations previously discussed, in the second position of the actuatable portion 6110 shown in FIGS. 8A-C, the gate element 6111 blocks the gravitationally fed entrance of the first money item routing 6300 and opens the entrance to the second money item routing 6400. In these circumstances, money items moving into the gate apparatus 6100 from the inlet 2000 of the system 1000 are guided by the gate element 6111 over the entrance of the first routing 6300 and into the second routing 6400.

The consistently repeatable second position of the actuatable portion 6110, which may be achieved by securing the actuatable portion 6110 against the second limit region in the manner described above, ensures that money items are optimally fed into the second routing 6400 of gate apparatus 6100. In particular, the avoidance of uncertainties in the specific position and orientation of the gate element 6111 means that the gate element 6111 consistently facilitates smooth flow of money items into the second routing 6400 without risk of disruption. For example, any risk of money items striking the distal end of the gate element 6111 due to a minor variation in the actuated position of the actuatable portion 6110 (e.g. the position shown in FIG. 7A) is avoided. Further, any risk of money items finding a way into the first routing 6300 through a gap between the distal end of the gate element 6111 and the frame 6140 of the gate apparatus 6100 is also avoided.

FIGS. 9A-C is a further series of views of the actuatable portion 6110 and actuator portion 6120. Consistent with the discussion above with respect to FIGS. 4A-8C, the further views in FIGS. 9A-C illustrate a transition of the actuator portion 6110 between first and second lock configurations. Also shown in FIGS. 9A-C is a corresponding movement of the actuatable portion 6110, including the engagement region 6113, between first and second limit regions. In particular, FIG. 9A shows the actuator portion 6120 in a first lock configuration analogous to FIGS. 4A-B, FIG. 9B shows the actuator portion 6120 in an intermediate configuration analogous to FIGS. 6A-B, and FIG. 9C shows the actuator portion 6120 in a second lock configuration analogous to FIGS. 8A-C.

In the implementation of FIGS. 9A-9C, the first and second limit regions are provided at least by portions 6141, 6142 of the frame 6140 directly adjacent to the engagement region 6113. For example, consistent with the discussion of FIGS. 4A-B, FIG. 9A shows a situation in which the drive element 6121 of the actuator portion 6120 has pushed a portion 6113C1 of a side edge 6113C of the engagement region 6113 into contact with an end stop provided by the adjacent portion 6141 of the frame 6140 and, in doing so, has locked the actuatable portion 6110 in a first position. On the opposite side of the engagement region 6113, a portion 6113B2 of the side edge 6113B is angled so that, as the drive element 6121 pushes the engagement region 6113 against the end stop 6141, the force applied to the engagement region 6113 by the drive element 6121 has a direction which is substantially normal to this portion 6113B2 of the side edge 6113B of the engagement region 6113. In other words, as the drive element 6121 pushes the engagement region 6113 against the end stop 6141, the shape and configuration of the engagement region 6113 is such that the angle of the portion 6113B2 of the side edge 6113B is substantially normal to a tangent of the rotation path where the drive element 6121 is located.

Similarly, consistent with the discussion of FIGS. 8A-C, FIG. 9C shows a situation in which the drive element 6121 of the actuator portion 6120 has pushed a portion 6113B1 of the side edge 6113B of the engagement region 6113 into contact with an end stop provided by the adjacent portion 6142 of the frame 6140 and, in doing so, has locked the actuatable portion 6110 in a second position. In the implementation shown in FIGS. 9A-C, as with the portion 6113B2 of the opposite side edge 6113B discussed above, the portion 6113C2 of the side edge 6113C of the engagement region 6113 is angled so that as the drive element 6121 pushes the engagement region 6113 against the end stop 6142 the force applied to the engagement region 6113 by the drive element 6121 has a direction which is substantially normal to the portion 6113C2 of the side edge 6113C of the engagement region 6113. In other words, as the drive element 6121 pushes the engagement region 6113 against the end stop 6142, the shape and configuration of the engagement region 6113 is such that the angle of the portion 6113C2 of the side edge 6113C is substantially normal to a tangent of the rotation path where the drive element 6121 is located.

In this way, the implementation illustrated in FIGS. 9A-C ensures that, at the first and second limit regions, the full magnitude of the force applied to the engagement region 6113 by the drive element 6121 is utilized in pushing the engagement region 6113 against the end stops 6141, 6142 in the frame 6140.

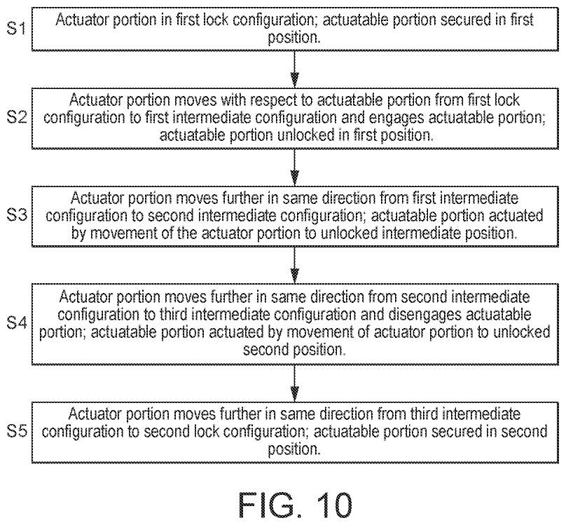

To supplement the information explained above, there now follows a description of operational stages of the self securing actuator apparatus described above, including the actuator and actuatable portions 6120, 6110, when implemented as part of the gate apparatus 6100. Reference is made to FIG. 10.

In a first stage S1, the actuator portion 6120 is in the first lock configuration shown in FIGS. 4A-B and 9A. The actuatable portion 6110 is secured by the actuator portion 6120 in the first position shown in FIGS. 2, 3, 4A-B and 9A. For example, in the gate apparatus implementations discussed above, the actuatable portion 6110 comprises a gate element 6111 which is secured in the first position to hold open an entrance to a first money item routing 6300 and hold closed an entrance to a second money item routing 6400.

As has been explained, movement of the actuatable portion 6110 out of the first position depends on the actuatable portion 6110 being released from the locked arrangement shown in FIGS. 4A-B and 9A. In order to do this, the drive element 6121 needs initially to be moved away from the first side 6113B of the engagement region 6113 by the powered drive mechanism 6130. While the drive element 6121 remains in the configuration shown in FIGS. 4A-B and 9A, the actuatable portion 6110 remains secured in the first position. This may be the case even in circumstances where the electric drive motor 6133 of the drive apparatus 6130 is powered off. In other words, the first lock configuration shown in FIGS. 4A-B and 9A may persist passively while the drive apparatus 6130 is static. There is no requirement to supply electrical power in order to retain the first lock configuration of the actuator portion 6120 and the corresponding first position of the actuatable portion 6110.

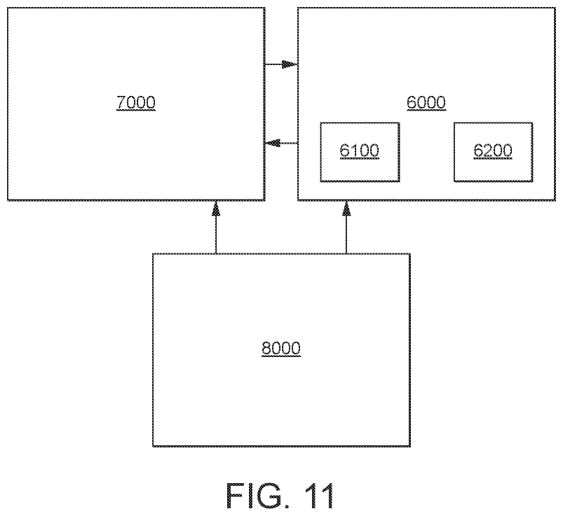

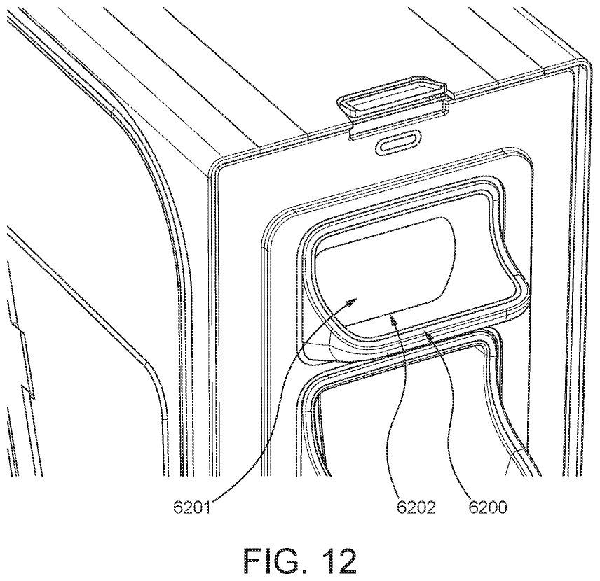

In a second stage S2, the actuator portion 6120 moves with respect to the actuatable portion 6110 from the first lock configuration shown in FIGS. 4A-B and 9A to the first intermediate configuration shown in FIGS. 5A-C. As described above, this involves the drive element 6121 following an arced path away from the first side 6113B of the engagement portion 6113 and into partial engagement with the receiving part 6113D on a different side of the engagement region 6113. Additionally, the rotatable element 6122 rotates relative to the engagement region 6113. This moves the curved perimeter surface of the rotatable element 6122 along the first correspondingly curved surface 6113A1 of the engagement region 6113. The movements of these components of the actuator portion 6120 are caused by the powered drive apparatus 6130 as previously described. For example, referring to FIG. 11, a control apparatus 7000 in communication with the drive apparatus 6130 may send an instruction to the drive apparatus 6130 to actuate the actuatable portion 6110 to the second position. In response, the drive apparatus 6130 may begin movement of the actuator portion 6120 in the first direction with an initial transition from the first lock configuration shown in FIGS. 4A-B and 9A to the first intermediate configuration shown in FIGS. 5A-C.

During this first stage of motion, the elements 6121, 6122 of the actuator portion 6120 move freely without any significant load from the actuatable portion 6110. This is because, during this phase, the drive element 6121 is not engaged with the engagement region 6113 of the actuatable portion 6110 and, as such, both elements 6121, 6122 of the actuator portion 6120 encounter minimal resistance to motion. The effect is advantageous for the apparatus 6100 as a whole, particularly the drive apparatus 6130. From a standing start in the first lock configuration, the drive apparatus 6130 is able to accelerate the elements 6121, 6122 of the actuator portion 6120, as well as its own moving components such as the worm and wheel gears 6131, 6132, to full operational speed before any significant load is encountered by engagement of the drive element 6121 with the receiving part 6113D of the engagement region 6113. As well as having the potential for more rapid movements of the actuatable portion 6110 between the first and second positions discussed above, this characteristic may improve longevity and durability of the apparatus 6100.

In a third stage S3, the actuator portion 6120 moves further in the same direction from the first intermediate configuration shown in FIGS. 5A-C to the second intermediate configuration shown in FIGS. 6A-B and 9B. As described above, this involves the drive element 6121 following its arced path to fully engage the receiving part 6113D of the engagement region 6113 and push the engagement region 6113 around the hinge 6112 (or alternative pivot) away from the first limit region and towards the second limit region. Additionally, continued rotation of the rotatable element 6122 relative to the engagement region 6113 brings the curved perimeter surface of the rotatable element 6122 out of alignment with the first correspondingly curved surface 6113A1 of the engagement region 6133 in the manner described above with respect to FIGS. 6A-B.

In this phase, the drive apparatus 6130 experiences load from the actuatable portion 6110 as the engagement region 6113 and gate element 6111 are moved towards the second position.

In a fourth stage S4, the actuator portion 6120 moves further in the same direction from the second intermediate configuration shown in FIGS. 6A-B and 9B to the third intermediate configuration shown in FIGS. 7A-C. This involves the drive element 6121 further following its arced path to push the engagement region 6113 and associated gate element 6111 into the second position of the actuatable portion 6110. In the second position of the actuatable portion 6110, the angle of the recess in the receiving part 6113D is aligned with the arced path of the drive element 6121 and so the driveable element 6121 begins to smoothly disengage from the receiving part 6113D without pushing the engagement region 6113 any further away from the first limit region and previously adjacent portion 6141 of the frame 6140. In fact, as explained above, in this third intermediate configuration of the actuator portion 6120 significant further movement of the actuatable portion 6110 is not necessary because the gate element 6111 is already very close to the second end stop provided by lip portion 6143 (or an alternative second limit region such as the frame portion 6142).

During the initial part of this fourth stage S4, before the disengagement process explained above, the drive apparatus 6130 continues to experience a load from the actuatable portion 6110 as the engagement region 6113 and gate element 6111 are moved towards the second position. Additionally, continued rotation of the rotatable element 6122 relative to the engagement region 6113 brings the curved perimeter surface of the rotatable element 6122 into partial alignment with the second correspondingly curved surface 6113A2 of the engagement region 6113.

In a fifth stage S5, the actuator portion 6120 moves further in the same direction from the third intermediate configuration shown in FIGS. 7A-C to the second lock configuration shown in FIGS. 8A-C and 9C. This involves the drive element 6121, now entirely disengaged from the engagement region 6113 and moving freely as in the initial phase of motion S2 discussed above, further following its arced path away from the receiving part 6113D of the engagement portion 6113 and towards the second side edge 6113C on the opposite side of the engagement region 6113 to where the arced path begun in the first stage S1. Here, the drive element 6121 comes into contact with the second side edge 6113C of the engagement region 6113 and once again exerts a force on the engagement region 6113 by pushing the first edge 6113B of the engagement region 6113 towards the newly adjacent region 6142 of the frame 6140. At the same time, the distal end of the gate element 6111 is pushed towards the lip portion 6143.

This final movement of the actuatable portion 6110 into contact with the second limit region provided by the lip portion 6143 (or alternative second limit regions mentioned above) ensures that the actuatable portion 6110 of the apparatus 6100 is fully in the second position discussed above and secured in place by the actuator portion 6120. In the event that the gate element 6111 is already optimally positioned in abutment with the lip portion 6143 upon arrival of the drive element 6121 against the second side edge 6113C of the engagement region 6133, then the final movement of the actuatable portion 6110 does not occur and the drive element 6121 instead simply secures the actuatable region 6110 in the second position. However, should there be any slack, this will be taken up by the final push from the drive element 6121 against the second surface 6113C of the engagement region 6113. As outlined previously, such slack might appear for a variety of reasons, such as manufacturing tolerances associated with plastics components, wear caused by previous operation of the system, expansion or contraction of system components due to temperature or other environmental factors.

As has already been highlighted, once the actuatable portion 6110 has been actuated to the second position shown in FIGS. 8A-C and 9C in accordance with the instruction received from the control apparatus 7000, it will remain secured in this position until the drive element 6121 is moved away from the second side edge 6113C of the engagement portion 6113. Retention of the second position does not require any power to be supplied to the drive apparatus 6130. Instead, the drive apparatus 6130 may be powered off to reduce power consumption. For example, upon the drive element 6121 making contact with the second side edge 6113C of the engagement region 6113 and applying a pushing force against the second limit region, the control apparatus 7000 may via a feedback signal from the drive apparatus 6130 detect a current or voltage which is indicative of the actuator portion 6120 having reached the second lock configuration. In absence of further instructions to move the actuatable portion 6110 back to the first position, the control apparatus 7000 may cause the drive apparatus 6130 to power down until such return movement is required.

As has been explained, in this fifth stage of operation S5, the drive element 6121 initially moves freely around its arced path without experiencing any significant load from the actuatable portion 6110. A corresponding effect is felt by the drive apparatus 6130. In particular, during this period of free running the electrical current drawn by the electric motor 6133 of the drive apparatus 6130 (e.g. from a mains or battery power source associated with the money item handling system) is significantly lower than the electrical current drawn during periods in which the drive element 6121 is exerting a force against the engagement region 6113 to move the actuatable portion 6110 between the first and second positions (or vice versa).

As this period of free running comes to an end and the drive element 6121 once again comes into contact with the engagement region 6113, for example by abutment with the second side edge 6113C of the engagement region 6113 as shown in FIGS. 8A-C and 9C, the electric motor load significantly increases. In particular, the electrical current drawn by the electric motor 6133 may significantly increase as the actuatable portion 6110 is pushed by the actuator portion 6120 against the second limit region (a corresponding effect is also seen when the actuatable portion 6110 is pushed by the actuator portion 6120 against the first limit region). This increase in electrical current at the motor 6133 is observable in the form of a current spike and is detectable by the control apparatus 7000 as part of the feedback signal from the drive apparatus 6130 referred to above. The control apparatus 7000 may use detection of the increase in motor current as a trigger to cease operation of the drive apparatus 6130.

The period of free running and associated low motor current which precedes the sharp current increase, as outlined above, may be beneficial for precisely detecting the moment at which operation of the drive apparatus 6130 should cease as the actuatable portion 6110 is pushed against the first and second limit regions. This is because the low motor current which directly precedes the current increase makes the increase more pronounced and thus more accurately detectable by the control apparatus 7000. This allows the operation of the motor 6133 to be ceased as early as possible once the gate element 6111 has reached its intended position, thereby protecting the motor 6133 from undue wear while ensuring that the actuatable portion 6110 is secured in its optimum end position.

The first to fifth stages S1-S5 described above with respect to FIGS. 10 and 11 may be implemented as a continuous movement of the actuator portion 6120 in a first direction between the first and second lock configurations. In other words, the actuator portion 6120 may be moved by the drive apparatus 6130 without pause or interruption through each of the stages S1-S5 to unlock the actuatable portion 6110 from its first position, actuate the actuatable portion 6110 to its second position and lock the actuatable portion in the second position. It will be understood that the reverse motion of the actuatable portion 6110 from the locked second position, for example as shown in FIGS. 8A-C and 9C, to the locked first position, for example as shown in FIGS. 4A-B and 9A, may be implemented in a corresponding fashion by carrying out corresponding reverse operations, i.e. by continuous movement of the actuator portion 6120 in an opposite (second) direction.

These motions of the actuatable portion 6110 may be completed using the single drive element 6121 described above and shown in the figures. The drive element 6121 may cooperate not only with the single recess of the receiving part 6113D to facilitate actuation of the actuatable portion 6110 between the first and second positions (and vice versa) but also with edge surfaces 6113B, 6113C on other sides of the engagement region 6113 to ensure that the actuatable portion 6110 is pushed fully against the first and second limit regions corresponding to those positions. Furthermore, the drive element 6121 secures the actuatable portion 6110 in place.

These functions are achieved without any requirement for the very fine motor control which may otherwise be necessary to ensure the actuatable portion 6110, and particularly the distal end of the gate element 6111, is stopped accurately in the second (or first) position. For example, by inclusion of the fifth stage S5 whereby the drive element 6121 moves into a position from which it may apply a final push to the engagement region 6113 to cause the actuatable portion 6110 to move into contact with the second limit region (or first limit region), the need for the drive element 6121 to disengage from the receiving part 6113D of the engagement region 6113 exactly in the final (required) position of the actuatable portion 6110, e.g., in full abutment with the lip portion 6143 or alternative end stop, is avoided. Although such accurate disengagement may be preferred, the final stage S5 of operation may be relied upon to fully close the actuatable portion 6110 against the limit region should this be necessary following disengagement of the drive element 6121 from the receiving part 6113D at the end of the fourth stage S4.

Using the self securing actuator apparatus described above with respect to FIGS. 2-9C, a gate element or another type of element can be actuated between two fully secured positions in a highly reliable and power efficient manner. Furthermore, the durability of the apparatus 6100 provided by its operational characteristics presents advantages over alternative systems. For example, a solenoid based system, in which a solenoid is arranged to move a gate element between first and second positions, generally requires continuous power to be supplied in order to maintain the gate element in at least one of its two positions (e.g. where the gate would otherwise naturally move back into its lowest potential energy state under gravity). Solenoid based systems also generate significant amounts of excess heat, which can undesirably influence the operation of other system components as well as consuming electrical energy.

While the self securing actuator apparatus including the actuator and actuatable portions 6120, 6110 has been described in the context of a gate apparatus 6100 for controlling the flow of money items between two different routings 6300, 6400 of a money item handling system 1000, the self securing actuator apparatus can alternatively be implemented in many other types of system where it is required to move an element between two secured positions. Use of the actuator and actuatable portions 6120, 6110 as generally described herein is not limited to money item handling systems or gate apparatuses.

As mentioned above with respect to FIG. 2, when implemented as part of an inlet control apparatus 6000 of a money item handling system 1000, the self securing actuator apparatus and associated gate apparatus 6100 may be accompanied by a flow restriction apparatus 6200. The flow restriction apparatus 6200 may configured to perform a plurality of different functions, depending on its selected mode of operation. A first operation mode is shown in FIG. 12. As can be seen from this figure, the flow restriction apparatus 6200 comprises a flow restriction element 6201 which is operable to selectively block or unblock any entry aperture 6202 of the inlet control apparatus 6000. In the operational mode illustrated in FIG. 12, the flow restriction element 6201 is actuated to a fully closed position so that money items are completely blocked from entering the gate apparatus 6100 and thus the interior region of the money item handling system 1000.

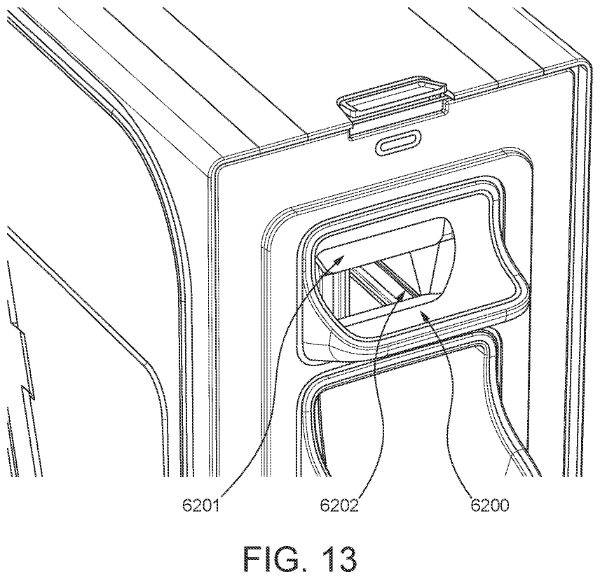

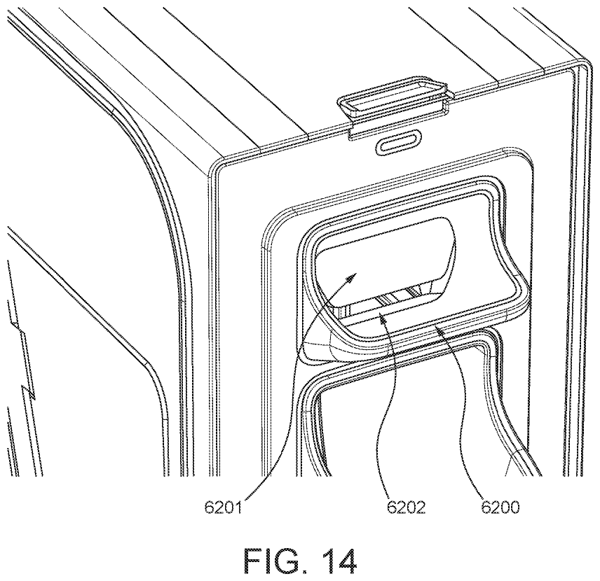

FIG. 13 illustrates a second operation mode of the flow restriction apparatus 6200. In this figure, the flow restriction element 6201 is actuated to a fully open position so that the maximum flow rate of money items through the gate apparatus 6100 is restricted only by the size and shape of the entry aperture 6202. FIG. 14 illustrates a third operation mode of the flow restriction apparatus 6200. In this figure, the flow restriction element 6201 is actuated to a partially open position so that the maximum flow rate of money items through the gate apparatus 6100 is significantly restricted relative to the second operation mode shown in FIG. 13. In the third mode, for example, the position of the flow restriction element 6201 may be such that money items may enter the gate apparatus 6100 only one-by-one.

These different operational modes of the flow restriction apparatus 6200 may provide significant functional flexibility and advantages for the system 1000. For example, in normal operation, the flow restriction apparatus 6200 may be operated in the third mode of FIG. 14 so as to ensure that large items of debris or other non-money items cannot pass into the system 1000. However, in order to permit a rapid bulk fill operation by a trusted person, such as service person, the flow restriction apparatus 6200 may operate in the second mode of FIG. 13 so as to allow large quantities of money items to be emptied into the system 1000 in a short amount of time. This is beneficial for the security of the system 1000 and the person involved in performing the bulk fill operation. The first operation mode of flow restriction apparatus 6200 is useful when it is temporarily desirable for no new money items to be entered into the system 1000. For example, in a situation where the system is out of use or powered down, it is desirable to prevent potential users from mistakenly entering new money items into the system 1000 as part of an attempted transaction. Other situations where it may be advantageous to prevent users from entering new money items into the system 1000 include where the system 1000 is carrying out internal operations in between transactions and is not yet ready for a new transaction to be initiated.

Referring again to FIG. 11, operation of the self securing actuator apparatus, the associated inlet control apparatus 6000 and other powered parts of the system 1000, may be controlled by the control apparatus 7000. For example, the control apparatus may comprise a computing apparatus which selectively controls actuation of the actuatable portion 6110 and/or flow restriction element 6201 between the different positions and operational modes described above by causing appropriate control signals to be supplied to the drive apparatus 6130 and corresponding drive apparatus (not shown) of the flow restriction apparatus 6200. The control apparatus 7000 may also selectively control movement of conveyors and other aspects of the money item handling system 1000, such as outlet gates, using further appropriate control signals.

The control apparatus 7000 may be communicatively coupled to a power supply 8000 of the system 1000. The power supply 8000 facilitates movement and control of the system parts discussed above, as required and instructed by the control apparatus 7000.

The control apparatus 7000 comprises at least one computer processor and at least one computer memory. The processor executes computer-readable instructions stored in the memory to cause the movement and functional control of the system 1000, including that of the elements specifically mentioned above. For the avoidance of doubt, the control apparatus may include a single processor or may comprise one or more architectures employing multiple processor designs for increased computing capability. The computer memory may comprise, for example, one or more read-only memories (ROMs), random access memories (RAMs), EPROMS, EEPROMs, Flash memories, magnetic or optical cards or application specific integrated circuits (ASICs). Additionally or alternatively, the computer memory may comprise any type of storage disk, such as one or more floppy disks, optical disks, CD-ROMs and/or magnetic-optical disks, or any other type of media suitable for storing electronic instructions which can be executed by the processor. The memory is coupled to the processor and other elements of the computing apparatus architecture via a computer system bus. The processor is configured to implement the instructions under the control of the computer-readable instructions to operate the system 1000.

It will be appreciated that there are various modifications and adaptations that can be made to the specific aspects of the system 1000 described above. The aspects described above may be used either singly or in combination. In this specification, the term “money items” refers, for example, to specifically minted coins or other tokens intended to be of monetary value.

1. A money item gate apparatus, comprising:
an actuatable portion;
an actuator portion comprising at least one drive element configured to move along an arced path between first and second configurations; and
at least one limit region;
wherein the at least one drive element is configured to sequentially:
move along a first section of the arced path to engage a receiving part of the actuatable portion at a first position of the actuatable portion;
move along a second section of the arced path to actuate the actuatable portion from the first position to a second position of the actuatable portion;
move along a third section of the arced path to disengage the receiving part at the second position of the actuatable portion; and
move along a fourth section of the arced path to secure the actuatable portion in the second position against the at least one limit region.

2. The apparatus of claim 1, wherein the at least one drive element is configured to secure the actuatable portion in the second position by exerting a force on the actuatable portion against the at least one limit region.

3. The apparatus of claim 2, wherein the at least one drive element is configured to exert the force on the actuatable portion by applying a push force on a first exterior edge of the actuatable portion against the at least one limit region.

4. The apparatus of claim 3, wherein the first exterior edge of the actuatable portion is on a different side of the actuatable portion to the receiving part.

5. The apparatus of claim 3, wherein the first exterior edge of the actuatable portion is on a substantially opposite side of the actuatable portion to a second exterior edge of the actuatable portion.

6. (canceled)

7. The apparatus of claim 1, wherein in the second position a gate element of the actuatable portion is in abutment with the at least one limit region.

8. (canceled)

9. The apparatus of claim 1,
wherein the apparatus comprises at least one further limit region; and
wherein, in the first position, the actuatable portion is in abutment with the at least one further limit region.

10. (canceled)

11. The apparatus of claim 1, wherein movement of the at least one drive element along the first section of the arced path starts at a first lock configuration of the actuator portion in which the at least one drive element secures the actuatable portion in the first position.

12. (canceled)

13. The apparatus of claim 11, wherein movement of the at least one drive element along the fourth section of the arced path ends in a second lock configuration of the actuator portion in which the at least one drive element secures the actuatable portion in the second position.

14. (canceled)

15. (canceled)

16. The apparatus of claim 1, wherein the receiving part comprises a recess in the actuatable portion into which the at least one drive element is configured to move at an end of the first section of the arced path.

17. The apparatus of claim 16, wherein the at least one drive element is configured to move out of the recess at an end of the third section of the arced path.

18. The apparatus of claim 16, wherein the at least one drive element comprises a pin which fits into the recess and applies rotary force to the actuatable portion as the actuatable portion moves between the first and second positions.

19. (canceled)

20. The apparatus of claim 1, wherein the actuatable portion comprises a gate element which, in the first position, facilitates a flow of money items into a first money item routing and, in the second position, facilitates a flow of money items into a second money item routing.

21. The apparatus of claim 20,
wherein, in the first position, the gate element blocks entry of money items into the second money item routing; and/or
wherein, in the second position, the gate element blocks entry of money items into the first money item routing.

22. The apparatus of claim 1, wherein the actuator portion further comprises a rotatable element having a curved perimeter surface for cooperating with at least one correspondingly curved surface of the actuatable portion adjacent to the receiving part.

23. (canceled)

24. The apparatus of claim 1, further comprising an electrically powered drive apparatus configured to selectively move the at least one drive element along the arced path.

25. The apparatus of claim 1, wherein the at least one drive element is configured to continuously and uninterruptedly move along the arced path in a first direction to cause the actuatable portion to be moved from the first position to the second position.

26. The apparatus of claim 25, wherein the at least one drive element is configured to continuously and uninterruptedly move along the arced path in a second direction opposite to the first direction to cause the actuatable portion to be moved from the second position to the first position.

27. A method of operating a money item gate apparatus, comprising:
moving at least one drive element of the money item gate apparatus along a first section of an arced path to engage a receiving part of an actuatable portion at a first position of the actuatable portion, wherein the at least one drive element is configured to move along the arced path between first and second configurations;
moving the at least one drive element along a second section of the arced path to actuate the actuatable portion from the first position to a second position of the actuatable portion;
moving the at least one drive element along a third section of the arced path to disengage the receiving part at the second position of the actuatable portion; and
moving the at least one drive element along a fourth section of the arced path to secure the actuatable portion in the second position against at least one limit region of the money item gate apparatus.

28. (canceled)

29. A non-transitory computer readable storage medium storing computer readable instructions which, when executed by at least one computing apparatus, cause the at least one computing apparatus to operate a money item gate apparatus to:
move at least one drive element of the money item gate apparatus along a first section of an arced path to engage a receiving part of an actuatable portion at a first position of the actuatable portion, wherein the at least one drive element is configured to move along the arced path between first and second configurations;
move the at least one drive element along a second section of the arced path to actuate the actuatable portion from the first position to a second position of the actuatable portion;
move the at least one drive element along a third section of the arced path to disengage the receiving part at the second position of the actuatable portion; and
move the at least one drive element along a fourth section of the arced path to secure the actuatable portion in the second position against at least one limit region of the money item gate apparatus.
